(19) United States
(12) Patent Application Publication
(10) Pub. No.: US 2007/0192391 A1
(43) Pub. Date: Aug. 16, 2007

(54) Direct digital synthesis radar timing system

(76) Inventor: Thomas Edward McEwan, Las Vegas, NV (US)

Correspondence Address: Thomas Edward McEwan, 8708 W. Gilmore, Las Vegas, NV, 89129, US

(21) Appl. No.: 11/351,924

(22) Filed: Feb. 10, 2006

(51) Int. Cl. G06F 1/02

(52) U.S. Cl. 708/271

(57) ABSTRACT

A direct digital synthesizer (DDS) drives a receive sampling gate at a frequency that is offset from a transmit pulse frequency to produce an expanded time sampled echo signal. The frequency offset generates a smoothly slipping phase between realtime received echoes and the sampling gate that stroboscopically expands the apparent time of the sampled echoes with an exemplary factor of 1-million and a range accuracy of 1-centimeter. The flexibility and repeatability of the digitally synthesized timing system is a quantum leap over analog prior art. The rock solid stability of the DDS allows further accuracy improvement via an error correction table.

### BACKGROUND OF THE INVENTION

1. Field of the Invention

The present invention relates to radar timing circuits and more particularly to precision swept delay circuits for expanded time ranging systems. It can be used to generate a swept-delay dock for sampling radar, Time Domain Reflectometry (TDR) and laser systems.

2. Description of Related Art

High accuracy pulse-echo ranging systems, such as wideband and ultra-wideband pulsed radar, pulsed laser rangefinders, and time domain reflectometers, sweep a timing circuit across a range of delays. The timing circuit controls a receiver sampling gate such that when an echo signal coincides with the temporal location of the sampling gate, a sampled echo signal is obtained. The echo range is then determined from the timing circuit, so high timing accuracy is essential. A stroboscopic time expansion technique is employed, whereby the receiver sampling rate is set to a slightly lower rate than the transmit pulse rate to create a stroboscopic time expansion effect that expands the apparent output time by a large factor, such as 100,000. Expanded time allows vastly more accurate signal processing than possible with realtime systems.

A common approach to generate accurate swept timing employs two oscillators with frequencies F_{T} and F_{R} that are offset by a small amount F_{T}−F_{R}=Δ. In a ranging application, a transmit clock at frequency F_{T} triggers transmit pulses, and a receive dock at frequency F_{R} gates the echo pulses. If the receive dock is lower in frequency than the transmit clock by a small amount Δ, the phase of the receive clock will slip smoothly and linearly relative to the transmit clock such that one full cyde is slipped every 1/Δ seconds. Typical parameters are: transmit clock F_{T}=2 MHz, receive clock F_{R}=1.99999 MHz, offset frequency Δ=10 Hz, phase slip period=1/Δ=100 milliseconds, and a time expansion factor of F_{T}/Δ=200,000. This two-oscillator technique was used in the 1960's in precision time-interval counters with sub-nanosecond resolution, and it appeared in a short-range radar in U.S. Pat. No. 4,132,991, “Method and Apparatus Utilizing Time-Expanded Pulse Sequences for Distance Measurement in a Radar,” by Wocher et al.

There are many influences that can affect the accuracy of the phase slip, including: (1) oscillator noise due to thermal and flicker effects, (2) transmit-to-receive clock cross-talk, and (3) thermal transients that typically do not track out between the two oscillators. The receive oscillator is typically locked to the offset frequency Δ by a PLL circuit, which does a reasonable job when the offset frequency is above several hundred Hertz. Unfortunately, precision long range systems require extremely high accuracy, on the order of picoseconds, at offset frequencies on the order of 10 Hz. A PLL system cannot meet this requirement for the simple reason that the PLL loop response must be slower than 1/Δ, or typically slower than 100 ms, which is far too slow to control short term phase errors between the two clocks.

U.S. Pat. No. 6,404,288 to Bletz et al addresses the problems associated with controlling low offset frequencies by introducing three additional oscillators into a system further comprised of seven counters and two phase comparators, all to permit PLL control at higher offset frequencies than the final output offset frequency, which is obtained by frequency down-mixing. This system is too complex for many commercial applications and like the prior art, it does not control instantaneous voltage controlled oscillator (VCO) phase errors and crosstalk.

Swept timing can also be implemented using analog techniques. Analog approaches to swept timing include: (1) an analog voltage ramp that drives a comparator, with the comparator reference voltage controlling the delay, or (2) a delay locked loop (DLL), wherein the delay between a transmit and receive clock is measured and controlled with a phase comparator and control loop. Examples of DLL architectures are disclosed in U.S. Pat. No. 5,563,605, “Precision Digital Pulse Phase Generator” by the present inventor, Thomas Edward McEwan, and in U.S. Pat. No. 6,055,287 “PhaseComparator-Less Delay Locked Loop”, also by the present inventor. The analog approaches are subject to component and temperature variations, and often require calibration during manufacture.

### SUMMARY OF THE INVENTION

The present invention overcomes the limitations of the various analog timing techniques used to generate a swept phase clock by digitally synthesizing the offset clock frequency for use in driving a sampling receiver.

The present invention provides a direct digital synthesizer (DDS) arrangement to provide timing for a pulse-echo rangefinder that can include, but is not necessarily limited to, (1) a frequency source for providing a transmit dock signal at a predetermined transmit clock frequency and for providing a DDS dock signal, (2) a transmitter triggered by the transmit clock signal for producing transmit pulses at the transmit clock frequency, (3) a DDS responsive to the DDS dock signal for producing a DDS output signal having an offset frequency from the transmit clock frequency, (4) a low pass filter for attenuating spurious frequencies in the DDS output signal and for producing a receive clock signal, and (5) a receiver responsive to the receive clock signal for sampling echoes of the transmit pulses, (5) wherein sampling echoes produces an expanded time output signal. The invention may further include a processor for processing the expanded time output signal, wherein the processor can have an error table for reducing timing system errors. The invention can further benefit from a frequency source that includes a DDS oscillator for providing the DDS cdock signal and a digital counter responsive to the DDS clock signal for producing the transmit clock signal. Alternatively, the frequency source can induce a transmit oscillator for providing the transmit dock signal and a VCO that is phase locked to the transmit clock or multiple thereof for providing the DDS clock signal. A counter can be beneficially included for dividing the receive clock signal to produce a lower frequency receive clock signal.

The present invention can be used in expanded time radar, laser, and TDR ranging systems having high stability, flexible programmability, excellent repeatability and manufacturability, and an uncorrected phase accuracy on the order of 0.2 degrees using currently available, low cost DDS chips. Applications include pulse echo rangefinders for tank level measurement, environmental monitoring, industrial and robotic controls, digital handwriting capture, imaging radars, vehicle backup and collision warning radars, and universal object/obstacle detection and ranging.

A beneficial embodiment of the present invention is to provide a precision radar timing system that generates a highly accurate and repeatable phase slip to produce accurate radar signal time expansions and corresponding ranging accuracies. A further beneficial embodiment is to provide a precision radar timing that is digitally and rapidly programmable. An even further beneficial embodiment of the present invention is to provide a precision radar timing system that is highly reproducible and inherently calibrated.

### BRIEF DESCRIPTION OF THE DRAWINGS

FIG. 1 is a DDS radar timing system of the present invention.

FIG. 2a depicts a single oscillator frequency source.

FIG. 2b depicts a two oscillator frequency source.

FIG. 3 is a receive clock divide-by-N counter.

FIG. 4 is a simplified DLL block diagram.

FIG. 5a is a DDS output with no sine read only memory (ROM) and no low pass filter (LPF).

FIG. 5b is a DDS output with a sine ROM and no LPF.

FIG. 5c is a DDS output with a sine ROM and LPF.

FIG. 6a is a DDS output phase plot with no sine ROM and with an LPF.

FIG. 6b is a DDS output phase error plot derived from the plot of FIG. 6a.

FIG. 7a is a DDS output phase plot with a sine ROM and LPF.

FIG. 7b is a DDS output phase error plot derived from the plot of FIG. 7a.

FIG. 8 is a time expanded 6 GHz echo pulse from a stroboscopic radar using a DDS timing system of the present invention.

### DETAILED DESCRIPTION OF THE INVENTION

A detailed description of the present invention is provided below with reference to the figures. While illustrative component values and circuit parameters are given, other embodiments can be constructed with other component values and circuit parameters. All U.S. Patents and copending U.S. applications cited herein are herein incorporated by reference.

General Description

Direct digital synthesis (DDS) generates frequencies by digitally accumulating phase in a manner that directly emulates the definition of frequency. Frequency ω can be defined by a rate of change in phase φ or 107 =φ/t, where t is time. This can readily be seen from the well-known relation φ=ωt. As time progresses, phase continually increases. Direct digital synthesis emulates this process by continually incrementing a digital phase value in discrete phase increments in a phase accumulator. It performs the accumulation in discrete time steps. The size of the discrete phase increment is set by a digital tuning word, and the discrete time steps are set by the DDS clock, i.e., the reference clock. Together, both define the synthesized frequency. This technique works well for low synthesized frequencies relative to the DDS clock frequency since a large number of small phase increments can be added in the phase accumulator to produce one full cycle spanning 0 to 2π in phase, and a very smooth progression in phase can be realized.

At synthesized frequencies of interest for radar timing, on the order of 2.5 MHz, current DDS chips can operate with a DDS clock on the order of 25 MHz. Thus, phase can only be incremented 10 times for each 0 to 2π output cycle at 2.5 MHz. The corresponding phase increments are 36 degrees, far too large for expanded time radar sampling. The sample interval in a 6 GHz expanded time radar must be on the order of 40 ps, which corresponds to 0.36 degrees of the 2.5 MHz clock cycle. Thus, the phase accumulator phase increments are one thousand times too large.

The situation can be vastly improved if the phase accumulator output is converted to equivalent sinewave voltages using a look up table (sine read-only-memory, or ROM) coupled to a digital-to-analog converter, or DAC. The resulting discrete sinewave output samples can then be smoothed, or reconstructed, into a continuous sinewave by a filter. As long as there are more than two samples per sinewave cycle, a reasonably accurate sinewave can be reconstructed by the filter. The filter attenuates spurious frequency components that include the DDS clock frequency, its harmonics, intermodulation components, amplitude and phase modulation components, and myriad aliased frequency components.

The filtered output from the DDS contains residual phase errors related to the number of accumulator bits, which can be fairly large, e.g., 34 bits, and by the sine ROM and DAC bit width, which can be 10-14 bits. The least significant bits (LSBs) from the accumulator are truncated to match the bit width of the DAC. A DDS in combination with a sine ROM, a DAC, and a reconstruction filter can provide an offset clock frequency having sufficiently small phase increments for sampling type stroboscopic radars.

The DDS, being digital, is not particularly subject to drift. Consequently, range errors produced by a radar ranging system can be mapped and used to correct DDS timing errors. A range error lookup table incorporated in a processor connected to the radar's expanded time output can accomplish this task.

Specific Description

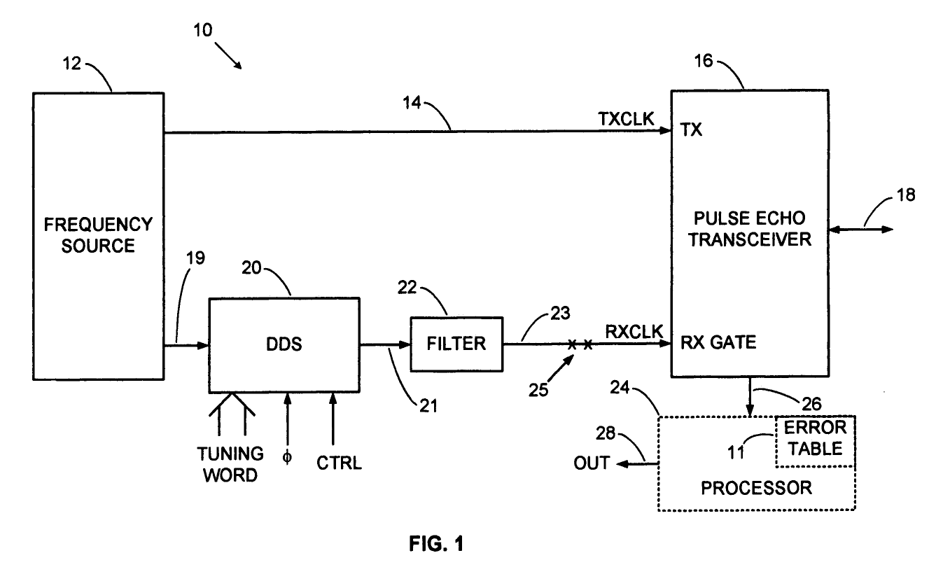

Turning now to the drawings, FIG. 1 is a block diagram showing a general configuration of a DSS timing system 10 of the present invention. A frequency source 12 provides a transmit clock signal on line 14, labeled TXCLK, at a predetermined transmit pulse frequency, which can be directed to pulse-echo transceiver 16. The TXCLK signal triggers transmits pulses in transceiver 16 at the predetermined transmit frequency. The transceiver radiates pulses, such as, for example, RF or optical pulses as indicated by line 18. In a TDR application, the transmitted pulses may travel along an electromagnetic guide wire, e.g., a Goubau line, or along other transmission line embodiments. The transmit pulse frequency is not to be confused with the transceiver's radiated RF or optical frequency. Transmit pulse frequencies can be on the order of 0.1 MHz to 10 MHz and radiated frequencies can be above one gigahertz thru optical frequencies.

Frequency source 12 also provides a DDS clock signal on line 19 to DDS 20. A tuning word (i.e., a phase-increment datum) and, optionally a phase input (denoted by φ in FIG. 1), is applied to the DDS, as well as routine control signals (denoted as CTRL in FIG. 1) to control data transfer and operation of internal registers and switches of the DDS. The tuning word is set to provide a DDS output signal on line 21 having a frequency that is less than ½ the DDS clock frequency. In particular, the tuning word is set to provide a DDS output frequency at an offset frequency relative to the transmit clock frequency on line 14. A filter 22 passes the DDS output frequency but attenuates the DDS clock frequency and other spurious frequencies, as the presence of these spurious frequencies degrades the overall timing system accuracy. Filter 22 is often configured as a smoothing or reconstruction filter but may often be configured as a lowpass or bandpass filter. The output of filter 22 is the receive clock signal on line 23, labeled RXCLK in FIG. 1, which is coupled on line 23 to the receiver sample gate input (denoted as RX GATE in FIG. 1) of transceiver 16.

Transceiver 16 may include a separate transmitter and a separate receiver, with corresponding separate radiating and receiving elements, e.g., antennas, or transceiver 16 may be a unitized transmitter and receiver and coupled to a single antenna, lens or TDR conductor.

Transceiver 16 samples echoes in response to the clock signal on line 23 and produces expanded time sampled echo signals on line 26. The time expansion effect is caused by sampling at an offset frequency from the transmit pulses, in a similar fashion to observing a rapidly rotating fan blade that appears to rotate slowly under a strobe light set to a strobe frequency that differs slightly from the blades' rotational rate. Accordingly, radars of this type are termed stroboscopic radars since they make realtime pulses propagating at the speed of light appear to propagate far slower, e.g., at the speed of sound. Expanded time signals are far easier to process accurately since the processing bandwidth is reduced in proportion to the time expansion factor.

Expanded time sampled echo signals are output from transceiver 16 on line 26. FIG. 8 is an oscilloscope plot of a stroboscopic 6 GHz radar implementation of FIG. 1, wherein several dozen receive samples 69 are continuously integrated together before being output on line 26, as shown in FIG. 1. Optional processor 24, as shown in FIG. 1, may be used to perform various processing functions known in the art, such as pulse detection, waveform averaging, spurious echo removal, range calibration and scaling, image processing, etc. The processor 24 outputs on line 28 for display, memory or control functions. Error table 11 can be used to correct range measurement errors by providing a lookup of error correction values at various ranges. The error table can be created by taking range measurements for system 10 and producing correction values from known range values.

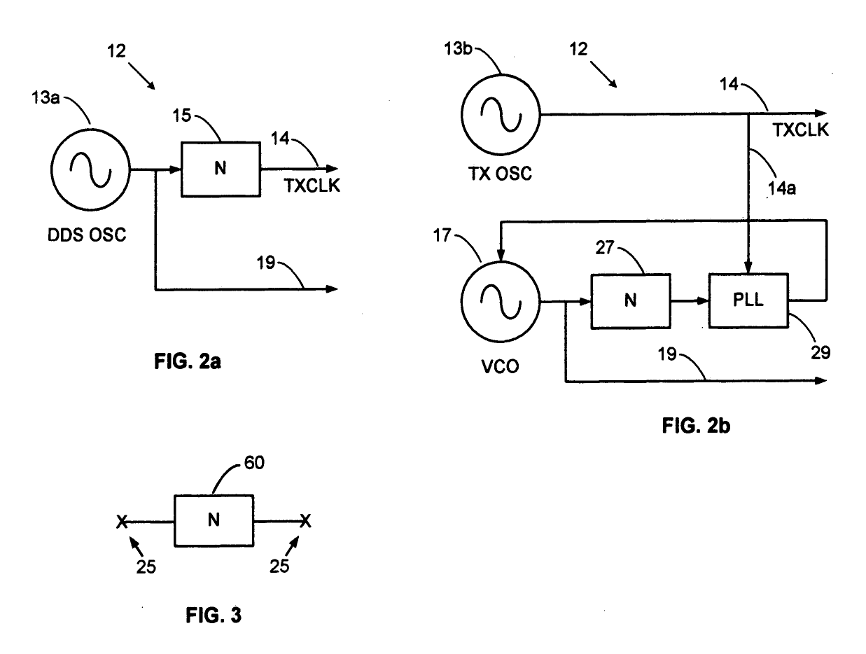

FIG. 2a depicts an embodiment of frequency source 12, which can include a DDS oscillator 13a that directly provides the DDS clock signal on line 19. The TXCLK on line 14 is provided by a digital divider 15 coupled to DDS oscillator 13a. The counter divides the DDS oscillator frequency by an integer N to produce a lower TXCLK frequency. This division is necessary since the DDS output frequency is lower than the DDS clock frequency, and the transmit and receive clock frequencies must be matched except for the offset frequency, or they must be matched by a harmonic except for the offset frequency. Harmonic operation is disclosed in U.S. Pat. No. 6,072,427, “Precision Radar Timebase Using Harmonically Related Offset Oscillators,” by the present inventor, wherein the second oscillator is formed of the DDS system herein. Example operating parameters can be DDS clock frequency=25 MHz, TXCLK frequency=25/16 MHz=1.563 MHz, and RXCLK frequency=6.25 MHz−10 Hz, where the 10 Hz is the offset frequency. The frequency word provided to the DDS is 6.24999 MHz.

FIG. 2b depicts another implementation of frequency source 12 wherein a transmit oscillator 13b directly provides the transmit clock signal on line 14. The transmit oscillator also provides a reference frequency on line 14a to a phase locked loop, encompassing VCO 17, divider 27 and PLL phase comparator/controller 29. The VCO 17 operates at a higher frequency than the transmit clock frequency and is phase locked to the transmit dock signal or a multiple thereof. VCO 17 provides a DDS clock signal on line 19, as shown in FIG. 1. The example configuration of FIG. 2b permits operation with a low frequency reference oscillator, and in particular allows the DDS clock to operate at a very high frequency, e.g., greater than about several hundred megahertz. Higher frequency DDS clocks allow more phase increments per unit time and can yield lower phase errors. With a higher frequency DDS clock, a DDS output as utilized in the present invention can be set to a much higher frequency than required by the receive clock frequency. In such a configuration, the X points 25 of FIG. 3 are connected at the X points 25 of FIG. 1 to insert a counter 60 that divides the filtered DDS output frequency on line 23 to a lower frequency for inputting to the RX Gate input of transceiver 16. Counter 60 divides by an integer N and reduces phase errors by N.

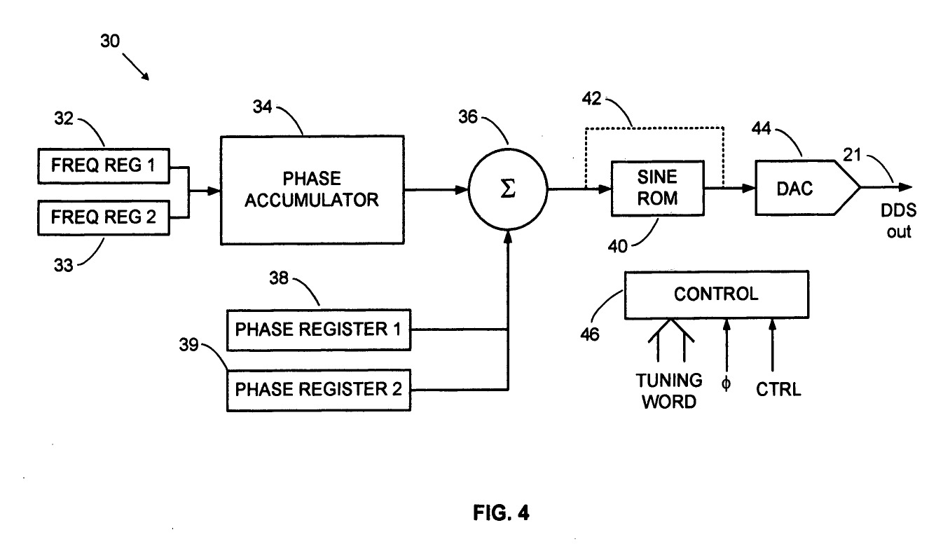

FIG. 4 is an example block diagram embodiment of a DDS of the present invention. For simplicity, not all details are shown, such as interconnects between control 46 to the various elements of the DDS, and the DDS clock line is not shown. Phase accumulator 34 adds numbers from frequency register 1 (ref 32), each number representing a phase increment to be added to the accumulator. A second frequency register 33 can be selected by control 46 to allow rapid frequency changes. The frequency registers are loaded from the tuning word input. In a stroboscopic radar application one register frequency may have a negative offset for normal operation, and the other register may have a positive offset for time reversed operation.

Time reversal has many uses, e.g., detecting the last echo in a series of echoes, whereby the last echo becomes the first when time reversed. This example is a glimpse into the real power of the DDS—frequency and phase can be changed rapidly and consistently, something that cannot be easily matched with analog systems. This new freedom allows manufacturers to rapidly reconfigure radar parameters under software control. For example, the maximum range of a tank liquid level sensing radar can be changed under software control to optimize SN, or the pulse rate can be changed to avoid range ambiguities. The DDS can also be programmed to implement range zooming or hopping between several different scan widths and ranges by suitably setting the frequency words.

The output of the phase accumulator 34 is applied to a summation element 36 which adds phase from selectable phase registers 1 or 2 (refs 38, 39) to provide a phase offset with as one example embodiment, a 10 bit resolution. Phase offset is particularly useful in adjusting range offsets in multi-static radar systems or for providing quadrature phase outputs. Summation element 36 outputs phase numbers to a sine ROM 40 which converts the phase numbers to sinewave amplitude numbers. Sine ROM 40 is typically 12 bits wide, whereas the phase accumulator output is often, as one example, 34 bits wide, so 22 bits are truncated. The sine ROM output is applied to DAC 44, which converts amplitude numbers into amplitude voltages to produce discrete output levels on output line 21 that represent stepped points on a digitally synthesized sinewave. A DDS is a numerically controlled oscillator, or NCO, that also includes a DAC, and preferably, a waveform ROM. Phase registers 38, 39 are a design option.

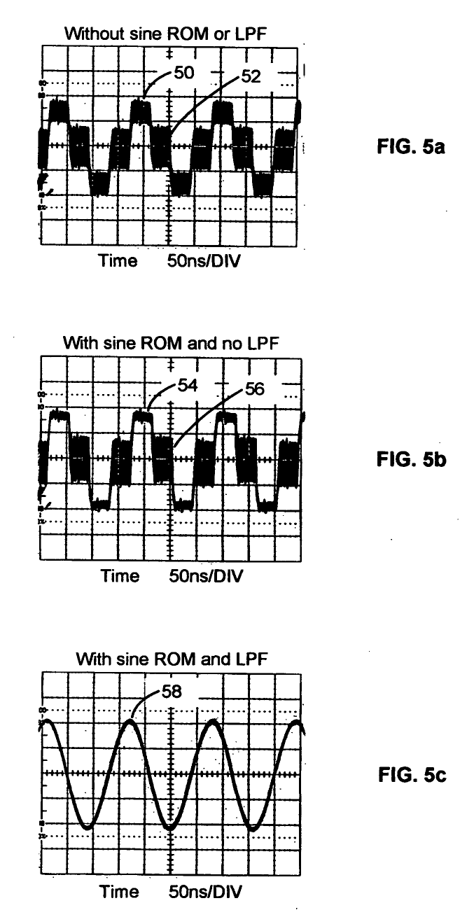

FIG. 5a is test data using an Analog Devices, Inc. model AD9833 DDS chip operating at a DDS clock of 25 MHz, an output frequency of 6.24999 MHz, and the sine ROM bypassed as indicated by dashed line 42 of FIG. 4. Without the sine ROM the DAC converts phase numbers into a triangle wave. However, without reconstruction filter 22, the DDS output on line 21 scarcely resembles a triangle wave and contains large phase and amplitude errors, or jitter, as indicated at 50 and 52 respectively. FIG. 5b shows the effect of introducing the sine ROM, wherein amplitude jitter 54 is reduced while there still remains a large amount of phase jitter 56. The phase jitter is 1000-times too high for a stroboscopic radar operating at 6 GHz. FIG. 5c shows the dramatic effect of adding a reconstruction filter 22, to filter out the high frequency components in FIG. 5b and produce a reasonably clean sinewave 58. It should be noted that reconstruction filter 22 can be integrated into some DDS chips and may not necessarily appear as a discrete filter 22 in some implementations.

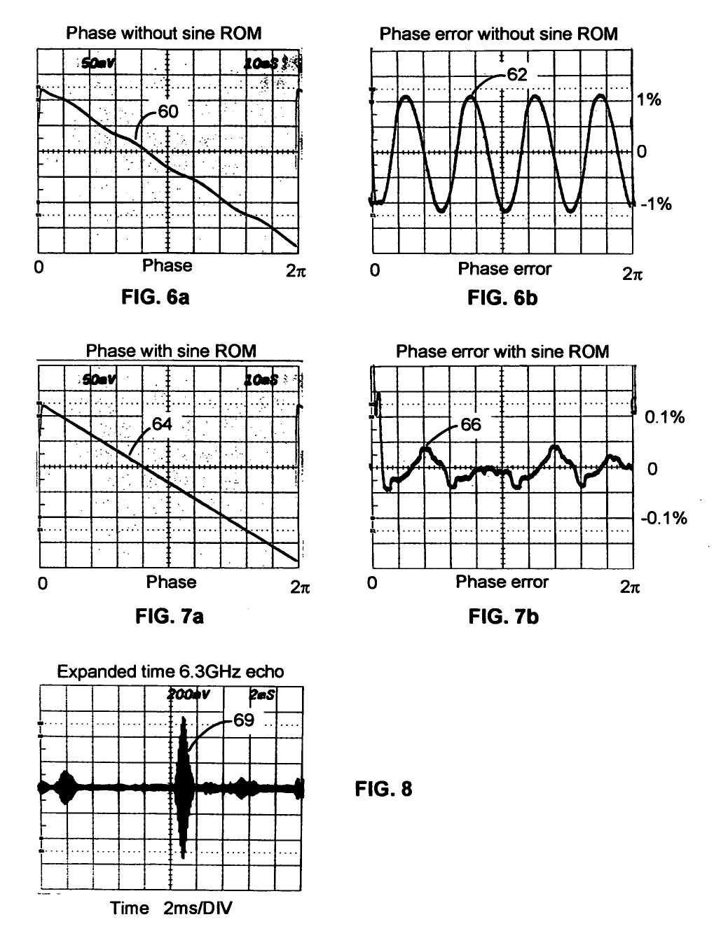

FIG. 6a is a plot of phase between transmit and receive docks for a DDS without a sine ROM. The plot spans 1 cycle, or 0 to 2π, and repeats at the slip rate. The frequency values for FIGS. 6-8 are given with respect to FIG. 2a. The phase plot 60 is a downward slope as a characteristic of the test system; it could also slope upwards. The test system for FIGS. 6a, 7a includes a phase comparator connected to the TXCLK and the RXCLK lines, with its output being lowpass filtered to provide the phase plots. Phase slope 60 is not very linear due to the absence of a sine ROM in the DDS. The errors 62 from a straight line are shown in FIG. 6b and are seen to be about 1% of full scale. This would be useable in low accuracy radar. The sine ROM is not essential to the invention.

FIG. 7a shows a resultant linear plot of the phase 64 when a sine ROM is used. FIG. 7b plots the errors 66 in phase from perfectly linear and the errors can be seen to be about +/−0.05% of full scale. This would correspond to a 1 cm range error in a stroboscopic radar having a 20 m maximum range. The error plots of FIGS. 6b and 7b were obtained by subtracting ramps 60, 64 respectively from a precision voltage ramp.

FIG. 8 is an expanded time radar echo output from a 6 GHz radar based on FIG. 1 and the frequencies cited with reference to FIG. 2. Receive samples, i.e., echo 69 is from a metal reflecting plate at 2 m range. The realtime pulse width of echo 69 is 1-ns. In expanded time, as plotted in FIG. 8, pulse 69 is about 1 ms wide, so the time expansion factor is 1 ms/1 ns=1-million, and the frequency of the cycles within pulse 69 is about 6 kHz, which can be easily processed with common op amps or data acquisition system. Pulse 69 is nearly identical in amplitude to the same system using a prior art analog timing system, proving the DDS timing system 10 of the present invention has sufficiently low realtime jitter, below 42 ps in this case, to not decorrelate the integrated receiver samples and produce a reduced amplitude sampled signal.

The use of the word “radar” herein refers to traditional electromagnetic radar that employs microwaves or millimeter waves, and it also refers to optical radar, i.e., laser rangefinders, as well as guided wave radar, wherein radar pulses are guided along a electromagnetic guide wire or other conductor, as in TDR. “Radar” includes monostatic and bistatic systems, as well as radars having a single antenna/transducer. The use of the phrase “offset frequency” generally refers to an offset frequency between 1 and 1000 Hz between transmit and receive clock signals. However, the scope of the invention also encompasses larger offsets as may be required in various applications. Changes and modifications in the specifically described embodiments can be carried out without departing from the scope of the invention which is intended to be limited only by the scope of the appended claims.

What is claimed is:

1. A Direct Digital Synthesizer (DDS) timing system for expanded time radar systems, comprising:
a frequency source for providing a transmit clock signal at a transmit dock frequency and for providing a DDS clock signal,
a transmitter triggered by the transmit clock signal for producing one or more transmit pulses at the transmit clock frequency,
a DDS responsive to the DDS clock signal for producing a DDS output signal at an offset frequency from the transmit clock frequency,
a filter for attenuating spurious frequencies in the DDS output signal and for producing a receive clock signal; and
a receiver responsive to the receive dock signal for sampling echoes of the transmit pulses, wherein sampling echoes produces an expanded time output signal.

2. The circuit of claim 1 further comprising a processor for processing the expanded time output signal.

3. The circuit of claim 2, wherein the processor further comprises an error table for reducing timing system errors.

4. The circuit of any of claims 1-3 wherein the frequency source comprises a DDS oscillator for providing the DDS clock signal and a digital counter responsive to the DDS clock signal for producing the transmit clock signal.

5. The circuit of any of claims 1-3 wherein the frequency source comprises a transmit oscillator for providing the transmit clock signal and a Voltage Controlled Oscillator (VCO) that is phase locked to the transmit clock or multiple thereof for providing the DDS clock signal.

6. The circuit of any of claims 1-5 further comprising a counter for dividing the receive clock signal to produce a lower frequency receive clock signal.

7. A method for time expanding radar signals, comprising:
generating a transmit clock signal at a transmit clock frequency,
transmitting radar pulses at the transmit clock frequency,
clocking a DDS at a multiple of the transmit clock frequency,
applying a tuning word to the DDS to produce a DDS output having a frequency that is offset from the transmit dock frequency,
filtering the DDS output to attenuate spurious signals and to produce a receive clock signal at a receive clock frequency; and
sampling echoes of the transmitted pulses at the receive clock frequency to produce an expanded time output signal.

8. The method of claim 7, further comprising: processing the expanded time output signal to produce a processed output signal.

9. The method of claim 8, further comprising: processing the expanded time output signal using an error table to increase the accuracy of the processed output signal.
